(19) United States
(12) Patent Application Publication
(10) Pub. No.: US 2005/0133712 A1
(43) Pub. Date: Jun. 23, 2005

(54) Scan pipelining for sensitivity improvement of orthogonal time-of-flight mass spectrometers

(75) Inventors: Mikhail Belov, Burlingame, CA (US); Peter Foley, Los Altos, CA (US)

Correspondence Address: WILSON SONSINI GOODRICH & ROSATI, 650 PAGE MILL ROAD, PALO ALTO, CA, 943041050, US

(73) Assignee: Predicant Biosciences, Inc., South San Francisco, CA (US)

(21) Appl. No.: 11/016,336

(22) Filed: Dec. 17, 2004

Related U.S. Application Data
(60) Provisional application No. 60/531,420, filed on Dec. 18, 2003.

(51) Int. Cl. H01J 49/00

(52) U.S. Cl. 250/287

(57) ABSTRACT

Methods and apparatus for analyzing ions by pipelining data acquisitions with an orthogonal time-of-flight (OTOF) mass spectrometer. A predetermined push sequence is established for launching packets of ions from a source region into a flight tube towards a detection region within the OTOF mass spectrometer such that ions which are launched in adjacent packets do not overlap prior to reaching the detection region. These discrete packets of ions do not intermingle and are launched in accordance with the predetermined push sequence along a propagation path from the source region toward the detection region such that portions of the packets of ions are simultaneously in-flight within the flight tube of the OTOF mass spectrometer. The times of arrival of ions are detected at the detection region to produce time-of-flight scans with signals corresponding to times of arrival for the ions in the launched packets of ions to provide a mass spectrum derived from pipelined data acquisitions.

### CROSS REFERENCES TO RELATED APPLICATION

This application claims the benefit of priority to U.S. Provisional Patent Application Ser. No. 60/531,420, filed on Dec. 18, 2003, which is incorporated by reference herein it its entirety.

### FIELD OF THE INVENTION

The invention relates to time-of-flight (TOF) mass spectrometers. More particularly, the invention relates to orthogonal time-of-flight (OTOF) mass spectrometers with improved sensitivity for use in proteomics and similar applications.

### BACKGROUND OF THE INVENTION

Mass spectrometry is an important tool in the analysis of a wide range of chemical compounds. In particular, mass spectrometry is expected to continue in its important role within the field of proteomics, the identification and characterization of proteins. A mass spectrometer is generally used to determine the molecular weight of sample compounds in a procedure that can be divided into three basic steps: formation of gas phase ions from sample material; mass analysis of the ions to separate the ions from one another according to their ion mass; and detection of the ions. A variety of alternative components exist today to perform each of these separate functions. The particular combination of such apparatus which is selected for a given mass spectrometer system inherently determines its unique characteristics.

The utility of mass spectrometry for studying biological molecules can be largely attributed to the dramatic advancements in what are referred to as soft ionization techniques such as matrix-assisted laser desorption ionization (MALDI) and electrospray ionization (ESI). Relatively large biological molecules can be now ionized without significant fragmentation. These ionization techniques rapidly expanded the class and range of molecules that can be analyzed which now include ions across a relatively large mass range. Mass spectrometers utilizing these ionization techniques are often coupled to time-of-flight (TOF) mass analyzers for separation. Other available types of mass analyzers include the quadrupole, the quadrupole ion trap, and the Fourier Transform ion cyclotron resonance (FT-ICR) devices.

Time-of-flight mass spectrometry plays a particularly important role in the analysis of biological compounds. These devices can be used for a wide range of applications which rely upon its relatively fast scan capability and high accessibility to ion sources such as an ESI source. The resurgence of interest in the time-of-flight mass spectrometry can be at least partially attributed to developments in laser or plasma desorption and electrospray ionization which can provide a complete mass spectrum with an extended mass range. Basically, the operation of most TOF mass spectrometers includes the common step of imparting a constant amount of kinetic energy to formed ions by applying an accelerating electric field. The underlying principle is that ions can be accelerated so they have equal kinetic energy which then allows them to be separated according to their different mass/charge (m/z) ratios. When relatively low energy ions are guided and allowed to collect in device region that can be referred to as an extraction region, an electronic pulse or voltage can be applied thereafter to a neighboring electrode to project ions into an electric-field-free region and are allowed to drift. This separation occurs as a function of mass, and because the ions travel a fixed distance and are detected by a detector, the “time-of-flight” can be accurately measured. The relatively lighter ions in principle reach and are detected by the detector before the relatively heavy ions. Accordingly, by measuring the flight time for the various sized ions from the ion source to the detector having predetermined dimensions and located in a fixed position, the relative ion mass can determined for the ions.

With respect to an orthogonal TOF (OTOF) mass spectrometer, ions are allowed to pass from the source into the analyzer along a direction that is orthogonal to the axis of the analyzer. Some of the advantages of using orthogonal acceleration include higher efficiency and mass analysis along an axis that is orthogonal to the ion beam so that the initial energy of the ions does not significantly degrade the mass resolution of the instrument. The level of sensitivity for a device is a very important parameter in many applications due to the relatively small amounts of sample that are typically available. Because an OTOF mass spectrometer generally operates at a relatively low duty cycle in order to cover a full mass spectrum for biological molecules that include peaks at the high m/z range, a lower repetition rate is observed which is known to adversely affect device sensitivity.

### SUMMARY OF THE INVENTION

The invention provides mass spectrometers with improved sensitivity. Various aspects of the invention can be applied to different types of mass spectrometer including orthogonal time-of-flight (OTOF) mass spectrometers. The concepts of the invention can be applied for the analysis of large macromolecules and complex biological samples such as cell tissues and proteolytic digests. It shall be understood that particular features of the described embodiments of the invention herein may be considered individually or in combination with other variations and aspects of the invention.

A preferable embodiment of the invention provides improvement of sensitivity in OTOF mass spectrometers by selecting a limited mass spectrum range during analysis. The lower m/z end of a mass spectrum and/or the higher m/z end of the mass spectrum may be adjusted to provide the desired range. A predetermined set of low and high m/z cutoffs may be selected so that ion species greater than or less than the established range are not detected. It has been observed that narrowing the mass spectrum range can increase the duty cycle for the instrument which tends to improve sensitivity and performance of the mass spectrometer. By defining a more limited mass spectrum range, the repetition rate established for an OTOF mass spectrometer can thereby be increased which also tends to improve instrument sensitivity. The repetition rate may be further increased in another embodiment of the invention by minimizing the dead-time between the acquisitions or pulses of ion packets being delivered through the mass analyzer. In this embodiment, multiple packets are simultaneously in-flight within the flight tube of the OTOF mass spectrometer. By launching a packet of ions into the flight tube before the arrival at a detector of the slowest and highest m/z species from a previous packet, the methods and apparatus herein achieve pipelining of the data acquisitions to provide an enhanced repetition rate which improves sensitivity of an OTOF mass spectrometer.

The methods and apparatus provided offer significant advantages over the traditional “pulse-and-wait” approach and those involving ion packets overlapping along a propagation path or within flight tube. The pulse-and-wait approach suffers from well recognized limitations such as low sensitivity and duty cycle, and those devices releasing overlapping packets require relatively complicated deconvolution of data to provide mass spectra information. The solutions provided herein employ the launching of ion packets, preferably within an OTOF mass spectrometer, according to a predetermined launch sequence and time interval such that the release of a subsequent packet is achieved before the heaviest ions of preceding ion packet reach a mass detector while taking care not to overlap and overtake such ions.

An OTOF mass spectrometer is thus provided herein that launched ion packets according to a predetermined time sequence or time interval. The time-of-flight mass spectrometer launches ions from a selected ion source such as an electrospray ionization device. The duration of a pulse for launching ions into the field free region of a flight tube in the mass spectrometer may vary and be timed at up to one microsecond or more. The ions released during this pulse or ion packet will drift along a propagation path of the field free region, and ions of different masses will separate. Relatively lighter ions will attain a relatively greater velocity than relatively heavier ions. As illustrated and described further herein, a sample of interest may be detected and analyzed yielding discernable peaks within a resulting mass spectrum, e.g., six peaks, corresponding to selected species, e.g., six species, in different concentrations. A selected group of species can be represented by peaks with particular mass-to-charge (m/z) ratios, e.g., ion species #1-6, wherein higher m/z species arrive at a detector later and have a relatively longer time-of-flight. As these ion species reach the detector, an electrical signal is generated corresponding to the intensity of the ions. These time/intensity signals as shown herein include peaks representing the concentration of corresponding ion species, respectively. These signals and resulting mass spectra are obtained by launching discrete packets of ions from the ion source according to predetermined time intervals. A subsequent ion packet is launched only after a sufficient time is allowed to pass to ensure that relatively lighter ions of the subsequent packet will not overtake the relatively heavier ions of a preceding packet. These precise pauses in between ion pulses can be variably timed such as up to hundredths of microseconds or greater, depending upon the system configuration parameters including the preselected acquisition rate for a desired mass spectrum. The resulting data acquisitions for each successive time-of-flight (TOF) scan can be thus pipelined. Accordingly, (TOF) scans may be efficiently obtained with minimal dead-time between ion pulses thus providing methods and apparatus herein with increased repetition rates and duty cycles.

Another advantage provided by the invention is a reduction or elimination of alias peaks in a mass spectrum. For instruments operated at high repetition rates, high mass species that are beyond the range currently being measured may appear (alias) incorrectly as low mass peaks in the following scan. These alias peaks for species beyond a defined mass spectrum range, which would ordinarily appear in the spectrum, can be substantially eliminated by employing both relatively lower and higher m/z cutoffs in the mass spectrometer in accordance with the invention.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE FIGURES

The figures contained in this specification and features illustrated therein describe many of the advantages of the invention. It shall be understood that similar reference numerals and characters noted within these illustrations herein can designate the same or like features of the invention. The figures and features depicted therein are not intended to limit the scope and nature of the invention, and may not be drawn to scale.

FIG. 1 illustrates conventional data acquisition with an OTOF mass spectrometer employing the release-and-wait approach.

FIG. 2 illustrates pipelined data acquisition with an OTOF mass spectrometer in accordance with an aspect of the invention that provides improved sensitivity and device performance.

FIG. 3 depicts another embodiment of the invention that provides pipelined data acquisition with synchronized deflection.

### DETAILED DESCRIPTION OF THE INVENTION

The invention provides methods and apparatus for improving the sensitivity and performance of mass spectrometers, and particularly for orthogonal time-of-flight (OTOF) mass spectrometers. These devices often rely on pulsing techniques for generating pulses of ion packets that travel orthogonally to the direction of an ion source beam which are known to provide certain advantages for time-of-flight applications. The various aspects of the invention can be combined or applied separately to offer the certain intended benefits as more fully described below.

An embodiment of the invention provides an OTOF mass spectrometer that includes an electrospray ionization (ESI) source for generating spectral scans derived from ion packets that fall within a defined or limited m/z range. It shall be understood that different ionization sources may be selected for use with the invention including variations of ESI that may be referred to as nanoelectrospray, nanospray and or micro-electrospray techniques. Such electrospray sources can be selected for their known capability of generating multiple charge states of proteins or peptides which can be particularly useful in certain applications. It is further recognized that the relevance and specificity of biological information obtained in the identification of certain peptide species is greatly increased when the molecular mass of these identified peptides exceeds several hundred Da or greater than 300 Da. In accordance with this aspect of the invention, a limited mass-to-charge (m/z) range may be thus selected for the detection and identification of ESI-protonated biomolecules that may be particularly suitable or adequate for a number of important biomedical applications. For illustrative purposes herein, a limited m/z range may be selected in some instances ranging between 400 Da to 3000 Da but it shall be understood that alternative lower and upper limits may be established for a defined mass spectrum range.

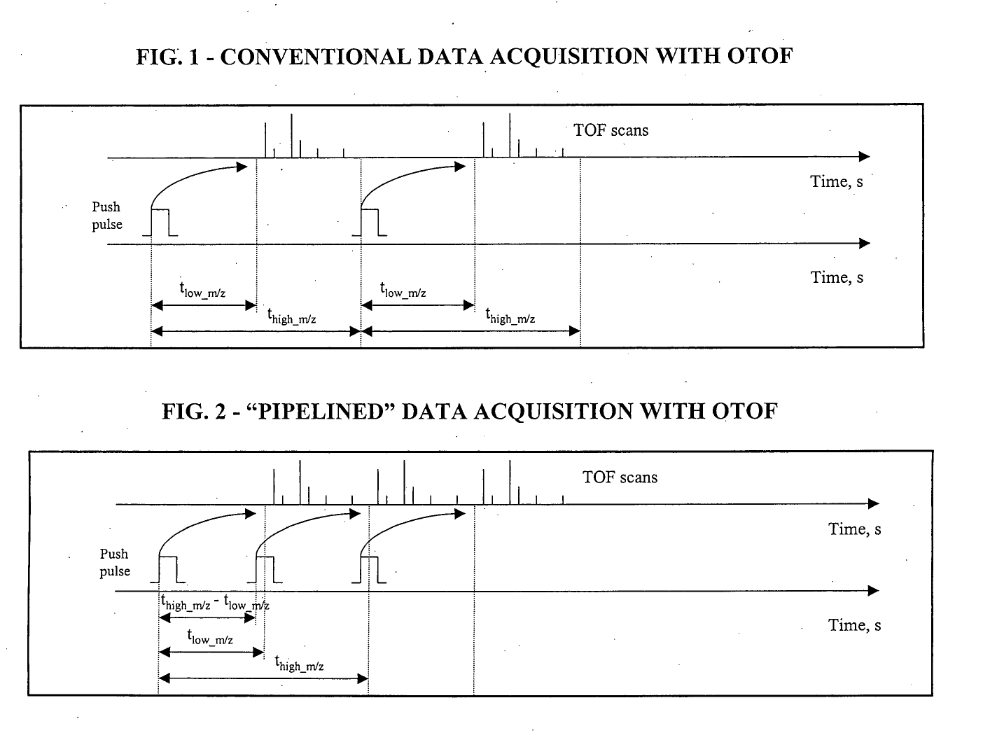

In accordance with one aspect of the invention, OTOF mass spectrometers can demonstrate significantly improved performance with a tailored decrease in the high m/z end of a mass spectrum. The improved sensitivity and performance of these devices can be at least partially attributed to an increase in the instrument duty cycle. Because OTOF mass spectrometers typically operate using a “release-and-wait” (“pulse-and-wait”) approach, ion packets are sent to an ion detector only after the highest m/z species from an earlier released ion packet from the previous cycle are detected. In general, the ions in OTOF devices are produced at atmospheric-pressure or relatively low pressure and allowed to expand continuously into a vacuum chamber. The packets of ions usually then enter an extraction region which is field-free so that ions of all masses can have the same kinetic energy when crossing this region without experiencing the influence of an electrical force. When an electrical or push pulse is supplied to a back electrode, the ions in the extraction region are then accelerated in a direction generally perpendicular to the original axis of the beam in the vacuum chamber. Although the ions attain different velocities depending upon the m/z ratio of the ions, it is known that the lower mass ions within the packets generally arrive at the detector prior to the heavier mass ions. By repeating this push pulse periodically, ion packets are thus generated at the repetition rate of the pulse. The ions are subsequently accelerated by a constant electrical field into a field-free region or flight tube, and are then detected and mass analyzed. When releasing the ion packets, there is a concern that the lighter and faster ions of a trailing packet will pass and overlap with the heavier and slower ions of a preceding packet. By using the traditional pulse-and-wait approach, the pulse and release of a packet is timed to ensure that ions of a preceding packet are able to reach the detector before the launch of another ion packet as shown in FIG. 1 in order to prevent packet overlap. The time-of-flight for low m/z ions within a selected ion packet is detected and measured before those for slower high m/z ions. The time/intensity peaks are generated as illustrated which represent the concentration of respective ions within the packet. The resulting TOF scans are thus derived for a given packet prior to the initiation of another push pulse and subsequent ion packet launch. As a result, the period of time between the launch of consecutive packets is relatively long which can lead to a relatively lower repetition rate. The interval between two adjacent arrivals of the same m/z species at the detector however generally includes data between the lowest and the highest m/z end region of a mass spectrum corresponding to detected ions and a delay corresponding to the time-of-flight of the lowest m/z species that is not of interest at all. By shortening an acquisition period and thus reducing the highest m/z end of the mass spectrum in accordance with an aspect of the invention for a selected sample of interest, the repetition rate and duty cycle can be increased which in turn enhances instrument sensitivity.

Given the aforementioned rationale for decreasing the highest m/z end of the mass spectrum, additional benefits of the invention may be further realized when increasing the lower m/z end of mass spectrum. The repetition rate can be further increased to improve sensitivity of the mass spectrometer when this is performed in addition to or in lieu of decreasing the highest m/z end of the spectrum. A variety of known techniques and apparatus may be selected to limit a resulting mass spectrum such as using a quadrupole ion guide and mass filters (e.g., quadropole(s) to filter a selected low m/z range in combination with a deflector positioned in a first spatial focus of an OTOF mass spectrometer to gate off a selected high m/z range) that would permit data acquisitions for gating off only selected ions of interest within a preset low and high m/z range. Accordingly, this embodiment of the invention directed to tailored low and high m/z end cutoffs can provide improved duty cycle and device sensitivity compared to those obtained by conventional approaches as illustrated FIG. 1.

Another embodiment of the invention provides enhanced instrument performance that minimizes the length or gap in time between date acquisitions or the launch of ion packets. The release of ion packets may be synchronized so that the lowest m/z species from a current ion packet can be controlled to arrive at a detector immediately following or after the highest m/z species from a previous ion packet. This achieves minimization of dead-time between two adjacent acquisitions in what may be described as “pipelining” the data acquisitions or scan pipelining as shown in FIG. 2. Multiple ion packets can be launched according to a predetermined sequence or time interval that results in at least some ions from more than one ion packet simultaneously in-flight within the flight tube of the OTOF mass spectrometer. This aspect of the invention may be applied to known apparatus and methods for releasing ion packets according to selected encoded sequences such as those described in U.S. Pat. No. 6,198,096 (Le Cocq) and U.S. Pat. No. 5,396,065 (Myerholtz et al.) incorporated by reference herein in their entirety. For example, a controller that controls the release of ion packets may be synchronized by a clock throughout the duration of a push pulse that is selected for a desired time interval such as one microsecond or less. By controllably launching a packet of ions down the flight tube at a selected time (wait time) before the arrival at a detector of the slowest and highest m/z species from a previous packet, a pipelining of the acquisitions is achieved to provide an enhanced repetition rate which improves the sensitivity and performance of an OTOF mass spectrometer. The initiation of a push pulse does not have to wait for high m/z range ions to reach a detector (see FIG. 1) and can be initiated beforehand. The sequencing of ion packet push pulses may be selected to prevent the overlapping of ions from adjacent or consecutive packets, and to ensure that the lighter and faster ions from a packet do not overtake the heavier and slower ions from a preceding packet or reach a detector at the same time. The resulting TOF scans for consecutive ion packets are therefore obtained more quickly and closer together in time. These synchronously pulsed consecutive ion packets travel along different portions of the flight tube simultaneously which however remain discrete and do not overlap with each other. Unlike other known techniques in practice today that intentionally intermix ion packets before detection, this aspect of the invention avoids having to use relatively complicated techniques, e.g., Hadamard transform techniques, to resolve such detected signals in order to provide mass spectra—see US 2004/0183007 (Belov et al) incorporated by reference herein in its entirety. An increase in repetition rate is thus observed utilizing the relatively simplified and efficient data acquisition solutions herein.

The increase in repetition rate provided by this aspect of the invention results in an increase to the duty cycle which thereby improves device sensitivity. The duty cycle of such OTOF mass spectrometers can be governed by Equation (1):

$$Duty\_cycle = \frac{Δ x}{[ \sqrt{\frac{m / {z}_{high}}{m / {z}_{low}} - 1} ] x + Δ x} \qquad ( 1 )$$

Wherein Δx is the detector width, x is the distance between the middle of the extraction region of the OTOF mass spectrometer and the detector, and m/z high and m/z low are the highest and lowest selected m/z values within a defined mass spectrum, respectively. For example, a 40 mm wide TOF detector can be positioned 45 mm away from the middle of the extraction region, and an m/z range may be selected ranging from about 400 to 3000 Da. The duty cycle for this configuration can therefore be calculated to be about 35%. As explained above, the duty cycle selected for a mass spectrometer can significantly affect the sensitivity of a time-of-flight mass spectrometer. When the ions with m/z values lower than 400 Da and higher than 3000 Da are delivered by an ESI source, they would typically appear as alias peaks in both the low and high m/z ends of a mass spectrum.

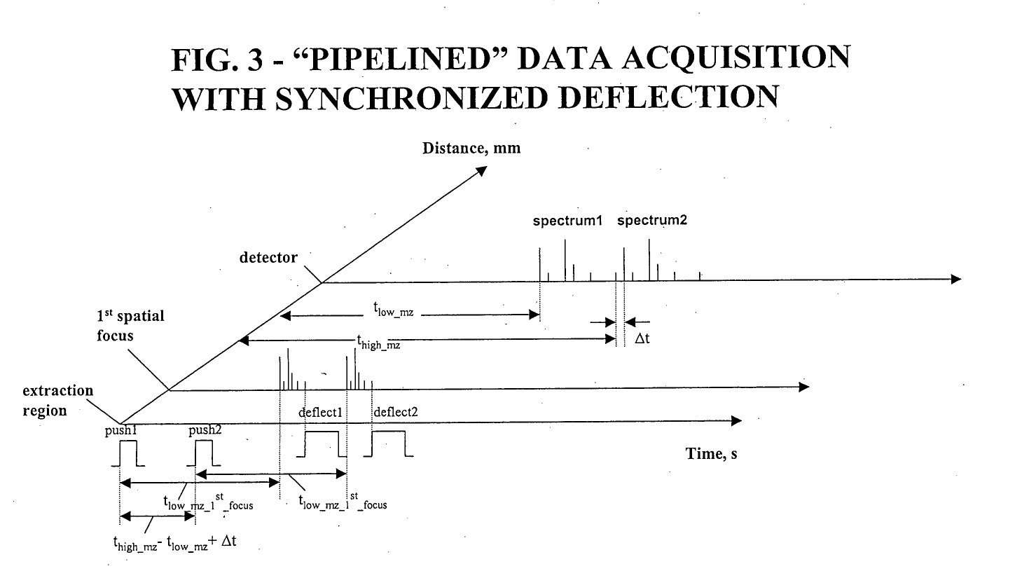

Another aspect of the invention provides elimination or substantial reduction of alias peaks in a mass spectrum. The “aliasing” of higher and/or lower m/z species can be eliminated or substantially reduced by employing either/both lower and higher m/z “cutoffs” in the mass spectrometer. Species with m/z values lower than 400 Da can be ejected from a mass analyzer using an rf-only quadrupole ion guide operating at q Mathieu of ˜0.9 for m/z 400 Da which can be derived from Equation (2):

$$q = \frac{4 z {V}_{rf}}{m {ω}_{0}^{2} {r}_{0}^{2}} \qquad ( 2 )$$

wherein V_{rf} is the peak-to-ground rf-potential, ω₀ is the angular rf-frequency, r₀ is the inscribed quadrupole radius, and m/z is the mass-to-charge ratio of an ion. Such an rf-only quadrupole may be positioned upstream of the extraction region of the OTOF mass analyzer. Meanwhile, species with m/z values higher than 3000 Da m/z can be removed by using pulsed ion deflection in a first spatial focus of an OTOF mass spectrometer. This deflection can be performed along the axis perpendicular to both the interface and TOF axis, and can be also synchronized with a pusher pulse of the OTOF instrument as shown in FIG. 3. A first push pulse (push1) can be initiated and followed by a second push pulse (push2) after a selected time interval that is sufficient to allow detection by a downstream detector of selected low m/z ions and high m/z ions plus an additional time spacer increment (Δt). Following each push pulse, a corresponding deflection pulse in the first spatial focus is generated which may include a first ion deflection pulse (deflect1) and a second ion deflection pulse (deflect2) to remove ion species from each corresponding packet with an m/z ratio higher than a predetermined high m/z end cutoff. The ion deflection for each respective packet preferably occurs only after detection of the selected ion species in order to provide the desired ranges of the mass spectrum below the high m/z end cutoff. A series of one or more deflectors may be placed at the first focal point so that deflection is precisely timed relative to the extraction of ions so as to deflect ions above the preselected mass range in a preferable embodiment of the invention. Based upon SIMION computer simulation and modeling techniques, a resolution of approximately 200 can be achieved for pulsed ion deflection in the first spatial focus, thus providing a relatively efficient tool for tailoring the high m/z end of the detected mass spectrum. Depending upon the mass spectrum received, a selected m/z range can be dynamically adjusted by modifying the low and high m/z cutoffs. The quadrupole ion guide may be programmed to block a new range of low m/z ions and/or the deflector plates at the first focal point can be set to deflect a different range of high m/z ions.

Another aspect of the invention provides methods of further increasing the duty cycle of OTOF instruments. The duty cycle can be increased even further by using data-dependent or dynamic adjustment of the high m/z end of a mass spectrum in the course of capillary liquid chromatography (LC)/capillary electrophoresis (CE) separations. The data-dependent adjustment of the high m/z end of a mass spectrum can be implemented in every other spectrum (e.g., acquired in every 3 s) using the mass spectral information from a previous acquisition. For example, when a signal at a particular elution time is detected in m/z range of 400 to 2000 Da, the delay for an ion deflection pulse and the mass spectrum acquisition time can be adjusted to match the flight time of m/z 2000 Da in data-dependent acquisition, and then subsequently switched back to those corresponding to a pre-set highest m/z range (e.g., 4000 Da) for broadband acquisition.

Another aspect of this invention provides a further increase in sensitivity of an OTOF mass spectrometer operating in conjunction with LC/CE separations aimed at identifying complex patterns of mass spectral peaks generated by up (or down) regulated protein/peptides expressed by cancerous cells in e.g. blood serum (i.e., biomarker pattern recognition). Given a known elution/migration time of species of interest (i.e., biomarkers), a complex data-dependent excitation waveform can be applied to one of the quadrupoles resulting in ejection of all other ions but the species of interest. This variation of the invention can be applied the methods and apparatus disclosed in U.S. patent application Ser. No. 10/810,332, which is incorporated by reference herein it its entirety. Note, that a data-dependent excitation waveform can be applied to the quadrupole during the elution period of species of interest, and quadrupole excitation can be then turned off to facilitate broadband spectrum acquisition. A continuous ion beam with a narrow m/z window corresponding to the biomarker ions can be transmitted to an OTOF mass spectrometer, whose pulser/acquisition rate would then be data-dependently increased resulting in an increase in the number of ion packets detected per separation peak. As quadrupole ion ejection can be routinely performed at a mass resolution of 100, spectrum acquisition rate would no longer be limited by the differences in arrival times of ions at low and high m/z end of a mass spectrum, but rather be determined by the time required to fill the extraction region of an OTOF mass spectrometer. The “fill time” of the extraction region can be governed by Equation (3)

$${t}_{fill\_extractor} = \frac{d}{\sqrt{\frac{2 z {U}_{interface}}{m}}} \qquad ( 3 )$$

Where d is the length of the extraction region along the interface axis, U_{interface} is the ion's kinetic energy along the interface axis, m/z is the ion's mass-to-charge ratio. Given U_{interface}=5 eV, d=40 mm and m/z=800 Da, ions of interest would fill up the extraction region in ˜35 μs, yielding an acquisition rate of ˜30 kHz. As compared to a time-of-flight of ˜200 μs for an ion with m/z 3000 in a typical OTOF mass spectrometer operating in the “release-and-wait” mode, this brings about a 6-fold increase in the instrument duty cycle.

The various improvements provided in accordance with the invention can be implemented individually or in combination with one another as described herein to provide improved sensitivity and performance of OTOF mass spectrometers. The apparatus provided herein demonstrate improved performance in comparison to conventional OTOF mass spectrometers currently available today. For example, the combination of pipelining the acquisitions and incorporating data-dependent adjustment of the high m/z end of a mass spectrum as described above can improve the duty cycle of the instrument by a factor of 3× or even greater. Moreover, when pipelining the acquisitions with high m/z deflection alone (not including data-dependent m/z range adjustment), the duty cycle has been observed to increase by a factor of 2× with a selected m/z range of 400 to 2000 Da. It should be further noted that the improved instrument sensitivity resulting from the increased repetition rate herein can be provided without aliasing of higher/lower m/z species within a selected mass spectrum. This is unlike certain commercially available systems where an increase in the repetition rate will be accompanied by peak aliasing when m/z species higher than the pre-set limit is detected. The proposed arrangements provided in accordance with the invention can provide instruments that are substantially free of alias peaks or “alias-peak-proof” while offering with higher duty cycle and sensitivity. It shall be further understood that various aspects of the invention may be applied and incorporated with known mass spectrometer apparatus and methods such as those described in U.S. Pat. No. 5,396,065 (Myerholtz et al.), U.S. Pat. No. 6,198,096 (Le Cocq), U.S. Pat. No. 6,300,626 (Brock et al.), U.S. Pat. No. 5,753,909 (Park et al.) and U.S. Pat. No. 5,614,711 (Li et al.), U.S. Pat. No. 6,770,870 (Vestal), US 2004/0108455 (Mordehai) and US 2002/0145110 (Holle), which are incorporated by reference in there entirety herein.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art upon reference to the present disclosure. It is therefore contemplated that the appended claims shall also cover any such modifications, variations and equivalents.

1. A method of analyzing ions by pipelining data acquisitions with an orthogonal time-of-flight (OTOF) mass spectrometer comprising:
establishing a predetermined push sequence for launching packets of ions from a source region into a flight tube towards a detection region within an OTOF mass spectrometer such that ions which are launched in adjacent packets of ions do not overlap prior to reaching the detection region;
launching packets of ions in accordance with the predetermined push sequence along a propagation path from the source region toward the detection region such that portions of the packets of ions are simultaneously in-flight within the flight tube of the OTOF mass spectrometer; and
detecting the times of arrival of ions at the detection region to produce time-of-flight scans with signals corresponding to times of arrival for the ions in the launched packets of ions to provide a mass spectrum derived from pipelined data acquisitions.

2. The method as recited in claim 1, wherein the packets of ions are launched into the flight tube by an extraction grid.

3. The method as recited in claim 2, further comprising the step of:
selecting a controller that is operatively connected to the extraction grid for launching the packets of ions at selected time intervals in accordance in accordance with the predetermined push sequence toward the detection region.

4. The method as recited in claim 3, wherein the predetermined push sequence includes a desired time interval in between the launching of a leading ion packet and a trailing ion packet within the flight tube so that relatively slow traveling ion species within the leading ion packet reach the detection region prior to the relatively fast traveling ions within the trailing ion packet.

5. The method as recited in claim 4, wherein the trailing ion packet is launched prior to the arrival at the detection region of the relatively slowest traveling ion species within the leading ion packet thereby minimizing dead-time between the respective time-of-flight scans.

6. A method of analyzing ions with a time-of-flight (TOF) mass spectrometer comprising:
establishing a predetermined push sequence for launching packets of ions from an ion source into a flight tube towards a detector within an TOF mass spectrometer such that ions which are launched in adjacent packets of ions do not overlap prior to reaching the detector thereby reducing dead-time between data acquisitions;
launching a plurality of packets of ions in accordance with the predetermined push sequence along a propagation path from the ion source toward the detector such that portions of the plurality of packets of ions are simultaneously in-flight within the flight tube of the TOF mass spectrometer; and
detecting the arrival times of ions at the detector to produce time-of-flight scans with signals corresponding to times of arrival for the selected ions within a desired m/z range within the packets of ions to provide a mass spectrum derived from pipelined data acquisitions.

7. The method as recited in claim 6, wherein the desired m/z range includes a preselected lower m/z end of the mass spectrum and a preselected higher m/z end of the mass spectrum.

8. The method as recited in claim 7, further comprising the step of: selecting a low m/z cutoff so that ion species with a lower m/z are not detected.

9. The method as recited in claim 7, further comprising the step of: selecting a high m/z cutoff so that ion species with a higher m/z are not detected.

10. The method as recited in claim 6, wherein the generation rate of ion packets is data-dependently adjusted based on the low and high m/z end of a mass spectrum, or on the time required for a selected ion to traverse an extraction region of the TOF mass spectrometer.

11. A time-of-flight (TOF) mass spectrometer comprising:
an ion source for delivering successive packets of ions in accordance with a predetermined pusher-pulse sequence, each packet containing a plurality of ion species with varying mass-to-charge (m/z) ratios;
a flight tube in which successive packets of ions travel simultaneously; and
a detector for detecting successive packets of ions which travel within the flight tube simultaneously, wherein the ion species within successive packets of ions do not intermix prior to reaching the detector thereby minimizing dead-time between data acquisitions for each ion packet.

12. The mass spectrometer as recited in claim 11, further comprising an accumulating region in which species from the ion source accumulate prior to release in the flight tube.

13. The mass spectrometer as recited in claim 12, wherein the ion source is positioned orthogonally to the flight tube.
